(19) United States
(12) Patent Application Publication
(10) Pub. No.: US 2021/0332450 A1
(43) Pub. Date: Oct. 28, 2021

(54) A PROCESS FOR TANNING ANIMAL HIDES

(71) Applicant: ECCO SKO A/S, Bredebro (DK)

(72) Inventors: Thomas GØGSIG, Bredebro (DK); Ilona COREMANS, Bredebro (DK); Panagiotis MYTAROS, Bredebro (DK); Thomas GREGOR, Bredebro (DK)

(73) Assignee: ECCO SKO A/S, Bredebro (DK)

(21) Appl. No.: 16/625,573

(22) PCT Filed: Jun. 26, 2018
(86) PCT No.: PCT/EP2018/067031

§ 371 Date: Dec. 20, 2019

(30) Foreign Application Priority Data
Jun. 26, 2017 (DK) PA 2017 70500

(51) Int. Cl. C14C 3/06; C14C 3/28

(52) U.S. Cl. CPC C14C 3/06; C14C 3/28

(57) ABSTRACT

A process for tanning animal hides comprising the steps of: providing a container comprising a pickled hide, a tanning agent and optionally an aqueous solution, where the total amount of water in the container is no more than 110% of the total water that can be retained by the pickled animal hide, and where the total amount of tanning agent in the container is no more than 110% of the total tanning agent that can be retained by the pickled animal hide, and basifying the animal hide to bind the tanning agent in the animal hide.

### TECHNICAL FIELD

A process for tanning animal hides comprising the steps of providing a container comprising a pickled hide, a tanning agent and optionally an aqueous solution.

### BACKGROUND

Pre-Soaking frees the raw material of dirt, such as blood dung and preserving salt and soaking returns it to its original water content. Soaking takes place at a pH between 8 and 10. In the liming step, Sulphur compounds as well as lime are added to remove the hair off the hide. The proteins are hydrolyzed, i.e. rendered water-soluble, and washed off. At the same time, the lime and Sulphur compounds used in the liming step, which have a powerful reducing effect, attack and rupture the polypeptide chains of the leather hide. This leads to greater mobility of the fibers, which endows the leather with enhanced extensibility and softness. This operation is also known as hide opening. During the entire liming operation, the hide undergoes a process of swelling due to becoming highly anionically charged and the attendant repellence between groups bearing the same charge.

In the fleshing step, remnants of tissue, flesh and fat are removed using sharp bladed rolls. To obtain uniformly thick leather in a desired thickness, the hide can be split. Fleshing and splitting is performed individually for each hide by hand and machine combined. The untanned leather hide is known as a pelt. A pelt has a water content of about 60 to about 80%. The dry matter is about 98% collagen.

The swelling induced in liming by the high alkalinity has to be eliminated before tanning in order that the tanning agents may penetrate into the fibrillar interstices of the hide fiber fabric. In the de-liming the calcium hydroxide in the hide is removed, where this is achieved by adding weak organic acids, for example aliphatic or aromatic dicarboxylic acids such as, for instance, sulphophthalic acid, or by adding weakly acidic inorganic salts, for example ammonium sulphate, ammonium chloride or polyphosphates.

In deliming, the calcium hydroxide in the hide is removed. Optionally, the hide can be further opened up using enzymes. Deliming and bating are performed in a somewhat heated float, i.e. at about 30 to 35° C. The bating and pickling operation takes about 8 to 24 hours at pH 2.5. The hide obtained after bathing and pickling is fully saturated with aqueous solution and is known as a pickled pelt.

At this point the actual tanning is carried out, conventionally taking 12 to 48 hours. The float ratio between the mass of tanning solution and the mass of pickled pelt to be tanned (i.e. the mass of hides fully saturated with aqueous solution) is between 8:1 and 1:1, although typically an excess of tanning solution is used. The tanning operation is frequently carried out in rolling drums and is then known as drum tannage. In addition to water and tanning agent, the tanning liquor contains, for example, salt, formic acid, sulphuric acid, sodium bicarbonate and further added substances. During tanning, the bonding-capable groups on the collagens undergo crosslinking with the tanning agents. The pH is raised to values between 3.6 and 4, by addition of alkali, in contradistinction to the bating and pickling operation.

On conclusion of the tanning operation, the tanning solution left over, i.e. not imbibed by the leather or fur to be tanned, represents wastewater which has to be disposed of. Tanning alone generates 160 to 200 million tons of wastewater worldwide. This wastewater has a considerable adverse impact on the environment unless it is cleaned up in a suitable manner. Tanning wastewater is customarily cleaned up in several stages, first for example by means of decanters to remove solids and then in a bio treatment stage. Wastewater cleaning is always time-consuming and costly and therefore is often not done in third world countries and threshold countries in particular. Instead, the wastewater is discharged dirty into rivers or lakes, where it leads to severe environmental damage.

U.S. Pat. No. 9,206,486 discloses a method of tanning animal skins where the process of tanning the animal skins comprises a conventional pickling of the animal skins, where the animal skins are sammied after the pickling state, and where the tanning and the basification stage is performed under in a closed container under high pressure and in environment of a compressed gas in the form of carbon dioxide.

This method however has the disadvantage that the apparatus used in this is very expensive as it needs to withstand a pressure of approximately 30 bars, and up to 200 bars, for a period of 15 minutes to approximately 30 hours. Furthermore the risk of catastrophic failures is significant, when working with high pressure containers for a significant amount of time. Furthermore, the amount of tanning agent used for the tanning process is disclosed to be around 80% more than the actual tanning agent that is to be imbibed in the skin, and where the pressure causes an over dosage of tanning agent of approximately 20 percent, where the tanning agent may be seen as an expensive chemical. When there is an increase of tanning agent to approximately 80% increase, the tanning agent has to be cleaned from the skin, which causes waste of a heavy metal such as Cr2O3 (Chromium sulphate), or the more expensive fungicide, such as Busan 1280.

Thus there is a need to provide a method of tanning an animal hide where the process may be safer, more cost effective as existing tanning equipment may be utilized and creating less waste of tanning agent.

### SUMMARY

In accordance with the invention there is provided a process for tanning animal hides comprising the steps of: providing a container comprising a pickled hide, a tanning agent and optionally an aqueous solution, where the total amount of water in the container is no more than 110% of the total water that can be retained by the pickled animal hide, and where the total amount of tanning agent in the container is no more than 110% of the total tanning agent that can be retained by the pickled animal hide, and basifying the animal hide to bind the tanning agent in the animal hide.

By limiting the amount of water in the container during the tanning process, it is possible to reduce the amount of tanning agent that is needed to fully tan the animal hide. In one example the tanning agent may be a mixture, where one of the tanning agents is Chromium Sulfate, in the form of Chromosal B. Chromium sulfate is a heavy metal, and in prior processes for tanning animal hides, it has been necessary to include an excess amount of Chromium sulphate to the tanning container, in order to ensure that the animal hide takes up enough of the chemical in order permanently alter the protein structure of the animal hide. The increased amount of tanning agent means that after the animal hide has been treated, the container comprises a significant amount of superfluous tanning agent that has not been introduced into the animal hide, or fixed our bound to the animal hide. This means that subsequently to the tanning, the superfluous tanning agent, which may be included in the superfluous aqueous solution in the container has to be drained from the container as a waste. As the waste includes a component that is defined as a heavy metal, it is necessary to send the superfluous waste to a treatment facility, to ensure that it is disposed of correctly to protect the environment.

If the amount of water in the container is more than 100-110% of the water which the animal hide can retain, this requires an increase of tanning agent, as there is a equilibrium between the animal hide and the surrounding water, which means that there has to be a certain concentration in the water for the tanning agent to penetrate the animal hide. However, if the container does not include excess water, the tanning agent that comes into contact with the hides penetrates the hides, and the flow ratio of tanning agent, that has already penetrated the animal hide, out of the hide is reduced significantly.

The tanning process is often performed in a container, such as a rotatable drum, where the pickled animal hide and the tanning agent, and optional water, is introduced into a tanning drum, where the container is often a closed cylinder which is rotated around its own axis for a predetermined length of time. The rotation and inside the container (drum) causes a the tanning agent to penetrate the animal hides, and testing has shown that if you limit the amount of water and limit the amount of tanning agent, it is possible to get the tanning agent to penetrate the animal hide in approximately three to six hours. This means that when the tanning process concludes, the container comprises very little excess water and therefore also very little excess tanning agent. If there had been provided approximately 150% tanning agent in the container, the container would have approximately 50% of the provided tanning agent excess inside the container when the tanning process is concluded, as the animal hide can only retain a certain amount. Thus, if there is remaining water in the container this water would have a large quantity of tanning agent, or alternatively, if the water content of the container is approximately 100% of the water amount which can be retained by the hide, the hides would have a large amount of tanning agent on the outside, which would have to be washed off the animal hide, and thereby create a contamination.

Thus, by limiting the amount of water inside the container and limiting the amount of tanning agent, it is possible to reduce the contamination of the tanning process, and reduce the volume of the water that needs to be run through a cleaning plant.

Furthermore, a further advantage of the present process, is that by limiting the amount of tanning agent in the tanning process, it is possible to lower the cost of tanning, as the cost of the tanning agent may be reduced significantly. This may both be related to the reduction in Chromium Sulfate, as well as a reduction in the amount of fungicides, where the cost of these chemicals is significant to the total cost of treating animal hides. The inventors have estimated that it would be possible to save approximately 20% on the tanning agents used pr. tonne of animal hide, and it is also possible to reduce both the use of clean water in the tanning process, thereby reducing the cost of the water in the process, while also reducing the amount of water that needs to be cleaned before it is reused or released into the environment.

The process is performed at atmospheric pressure, or optionally where the pressure inside the container is substantially similar to the pressure surrounding the container. Optionally the process may be performed in a non-pressurized container. This means that the pressure inside the container is maintained similar to that of the surrounding volume, without actively increasing it during the tanning process. However it may be foreseen that an increase in temperature inside the container may change the pressure inside the container slightly, but for the present method it is advantageous that the container is not airtight, or has a safety valve that opens up if the pressure rises above 1.2-2 atm's, as any increase in pressure inside the container may be seen as hazardous, both to the machinery and to the operators that are working with the machinery. Alternatively the container may be provided with an air valve that opens every time the valve is above the centre line of the container or rotating drum, while the valve closes when it extends below the centre line.

The term “substantially similar to the pressure surrounding the container” means that the pressure inside the container may be within the range of 50-150% of the pressure outside the container, optionally within the range of 70-130% of the pressure outside the container, optionally within the range of 90-110% of the pressure outside the container, optionally in the range of 95-105% of the pressure outside the container. The term means that the pressure inside the container is not regulated to a higher or a lower pressure than the surroundings of the container where any pressure increase may be the effect of chemical reactions inside the container, temperature changes inside the container, or other by-products of the tanning process.

In one embodiment the container is a closed system during the tanning process. The container may be seen as a container that is capable of holding the animal hide, any water and/or aqueous solution that is used for the tanning process, any tanning agent that is introduced in dry, solid, liquid, wet or in any form, without changing the concentration of the components inside the container. The container may be a rotatable drum, that has an hatch that may be opened to introduce the animal hides, the aqueous solution or the tanning agent. The container is configured to retain the components used for the tanning process. Furthermore, the container may be adapted to be heated, in order to increase the temperature inside the container, in order to speed up the tanning process, and/or in order to complete the tanning process by fixing or binding the tanning agent to the animal hide. The increase in temperature may be from approximately ambient temperature (approximately 20-22 degrees Celsius) to 30-50 degrees Celsius. Alternatively, the inclusion of Wet Bright might be utilized to bind the tanning agent to the hide and/or the collagen of the hide.

In one embodiment the animal hide is sammed and/or where the water retained in the animal hide is reduced to approximately 50-90% of the total water that can be retained by the pickled animal hide, prior to providing the animal hide in the container. If the animal hide is sammed prior to the introduction into the container, to remove parts of the pickling solution from the animal hide, it may be seen as being important to introduce an additional aqueous solution, pickle solution and/or water into the container. The sammying of the animal hide may assist in cleaning the animal hide, where the sammying removes fibres from the animal hide or absorbs grease. The sammying machines absorb the grease from the hide during the wet process in tanneries, either wet blue or wet white. The sammying machine may be equipped with 2 or 3 or 5 or 6 pressure rollers that press the hide in order to take out the fats and/or the water content. The more the sammying machine is equipped with pressure rollers, the more productive can be the sammying machine. The hide is conveyed on felts through the sammying machines which absorb the fats and/or the water content and as well the pressure by the rollers.

In one embodiment an aqueous solution is added to the container so that the total amount of water in the container does not exceed more than 110% of the total water that can be retained by the pickled animal hide. If the water content of the animal hide is less than the maximum amount that can be retained in the animal hide, prior to the tanning of the hide, it may be advantageous to provide additional water into the container to increase the total amount of water inside the container up to a degree that is close to or the total amount of water that may be retained in the animal hide. The aqueous solution that is added to the container may be any suitable aqueous solution, such as a reusing of the pickling solution and/or fresh water.

In one embodiment the tanning agent may be one or more chemicals that are provided in a mixture or individually. The tanning agent used for tanning animal hides may be including but not limited to chromium sulphate and its derivates, vegetable extracts, glutardialdehyde, fatty oils in particular and other mineral salts based on aluminium, zirconium, titanium, iron, silicates, etc. and synthetic tanning agents based on acrylics acrylic copolymers, polyphenols, polysulphonic acids and condensates thereof, etc. The tanning agent may further comprise additional components such as Fungicides (Busan 1280), or other additives that may provide additional qualities to the tanned leather or the tanning process. The tanning agent may include other additives such as: electrolyte stable fat liquors or slippery agents. The tanning agent may be provided to the container in any form, where each component is introduced separately or in a mixture, which may be in solid or liquid form.

In one embodiment the total amount of water that can be retained in the animal hide, or the total amount of tanning agent may be calculated based on the initial weight of the animal hide prior to a de-liming step of the animal hide. The animal hide, prior to the de-liming step, has a specific water content, where the water content of the animal hide may depend on the type of animal hide, the thickness of the animal hide, the size of the animal hide, etc. Within the technical field of tanning animal hides, the water content is a specific type of animal hide is known. Thus, prior to the de-liming step, the animal hide may be weighed, so that the initial weight of the animal hide indicates the total amount of water in the hide, as well as the pelt weight, which is the weight of the hide after it has been de-limed. Furthermore, when the animal hides have been pickled, the weight of the hides may be registered, where the water content of the pickled hides is approximately 100% of the total weight of the water that may be retained by the hide. If the hide is sammed, the weight of the liquid released from the hide may be registered, or the weight of the sammed hide, so that it is possible to know how much water has to be added to the hide in order to obtain the 100% mark.

After fleshing/splitting the weight of the hide is measured. There is added approximately 4.1% of Chrome Sulfate based on the Pelt/hide Weight. After samming there may be 4.8% Chrome Sulfate based on the weight of the pickled hide prior to samming. The weight reduction from Pelt/hide weight to Pickle weight is around 15% with the reduction from 4.8 to 4.1% chrome sulfate.

In one embodiment the total amount of water in the container is no more than 105% of the total water that can be retained by the pickled animal hide, or wherein the total amount of water in the container is no more than 100% of the total water that can be retained by the pickled animal hide, or wherein the total amount of water in the container is no more than between 90-99% of the total water that can be retained by the pickled animal hide. It has been shown in tests that if the water content of the animal hide is closed to 90-99% of the total water that can be retained by the pickled animal hide, it is possible to introduce the entire amount of tanning agent into the animal hide. In case where the water content is less than 100% the amount of time which the hides are to be tanned may be increased, to ensure a full saturation (introduction of tanning agent into the animal hide) is obtained. It is advantageous that if the total amount of water in the container is no more than 100% of the total water that can be retained by the pickled animal hide it is possible obtain a full saturation of the tanning agent into the animal hide, without having additional water in the container. Not having additional water means that when the tanning process is finished, there is no waste water remaining in the container, and therefore no waste water that has to be disposed of.

In one embodiment the total amount of tanning agent in the container is no more than 105% of the total tanning agent that can be retained by the pickled animal hide, or the total amount of tanning agent in the container is no more than 100% of the total tanning agent that can be retained by the pickled animal hide. By introducing only the necessary amount of tanning agent into the container, it is possible to reduce the waste material significantly compared to prior art methods of tanning an animal hide. The reduction in tanning agent, to approximately the amount that can be retained by the animal hide, and running the tanning process, it is possible to introduce substantially all of the tanning agents into the hide, by processing it as given e.g. in the following examples.

In one embodiment the pH of the aqueous solution is less than 7, or more preferably less than 6, or more preferably less than 5, or more preferably less than 4. It is advantageous for the aqueous solution in the tanning process to have a low pH, below 4, as the tanning agent, such as Chromium Sulfate, is soluble in acidic conditions, and is therefore adapted to penetrate the hide in acidic conditions. The pH may be lowered in the process by introducing acids in a single component or as a mixture of acids, where the acids may be e.g. Formic acid (HCOOH) or Sulfuric acid (H2SO4).

### EXAMPLES

### Example 1

This example discloses a tanning process of an animal hide, where the animal hide is drained after pickling and introduced into a tanning drum (container), and where the amount of tanning agent (Baychrome A, Busan 1280, Dilution water for Busan) has been added as a percentage of the weight of the pickle.

The pickle weight of the animal hides was 9115 Kg, and the animal hides were introduced into the tanning drum (container) where the animal hides were only drained, and not sammyed. Thus, the pickle weight represents the animal hides having a water content that is substantially 100% of the total water that can be retained in the animal hide.

Based on calculation on the pickle weight, 4.8% (438 kg) of a tanning agent, Baychrome A, was introduced into the container in powder form. In addition to this 0.2% (18.2 kg) of fungicide, Busan 1280, was introduced into the container, as well as 1.30% (118.5 kg) water for diluting the fungicide was introduced into the container.

The following table shows the amount of time in minutes and the temperature of the tanning process to obtain tan the animal hides in accordance with the process in accordance with the invention.

| Time | Temperature |
|---|---|
| 360 | Ambient |
| 60 | Temp: 29° c. |
| 60 | Temp: 31° c. |
| 60 | Temp: 33° c. |
| 60 | Temp: 36° c. |
| 60 | Temp: 39° c. |
| 180 | Temp: 42° c. |

The use of Baychrom A, which is a self basifying Chrome Sulfate, there may be no need for additional basifying agent, and the basifying may be obtained by increasing the heat inside the container as well as approximately 8 hours of tanning. Alternatively, the resulting animal hides were subsequently basified, according to conventional basification methods. As an example, the basification may be performed by the introduction of 0.4% (36.5 kg) Feliderm MgO into the container, where the basification process may be run for eight hours.to bind the tanning agent in the animal hides.

### Example 2

This example discloses a tanning process of an animal hide, where the animal hide is sammed after pickling and introduced into a tanning drum (container), and where the amount of tanning agent (Baychrome A, Busan 1280, Dilution water for Busan) has been added as a percentage of the weight of the pickle.

The pickle weight of the animal hides was 8121 Kg, and the animal hides were introduced into the tanning drum (container) where the animal hides were sammyed. The weight of the pickle float that was sammyed from the pickle weight was 2277 kg, and therefore the weight of the pickled hides was 5844 kg. Thus, the pickle weight represents the animal hides having a water content that is substantially 72% of the total water that can be retained in the animal hide, as the weight pickle float is approximately 28% of the pickle weight.

Based on calculation on the pickle weight, 4.8% (390 kg) of a tanning agent, Baychrome A, was introduced into the container in powder form. Alternatively, it may be added in liquid form after dilution in the pickle solution. In addition to this 0.2% (16 kg) of fungicide, Busan 1280, was introduced into the container, as well as 1837 kg of pickle float, along with 0.4% (32 kg) of Liquid slippery agent (Zeteslip ECS) Due to the introduction of pickle float there was no need to dilute the fungicide (Busan 1280) and this was combined with the pickle/or tanning agent solution.

The following table shows the amount of time in minutes and the temperature of the tanning process to obtain tan the animal hides in accordance with the process in accordance with the invention.

| Time | Temperature |
|---|---|
| 180 | Ambient |
| 60 | Temp: 29° c. |
| 60 | Temp: 31° c. |
| 60 | Temp: 33° c. |
| 60 | Temp: 36° c. |
| 60 | Temp: 39° c. |
| 180 | Temp: 42° c. |

The resulting animal hides were subsequently basified, according to conventional basification methods. As an example, the basification may be performed by the introduction of 0.4% (36.5 kg) Feliderm MgO into the container, where the basification process may be run for eight hours.to bind the tanning agent in the animal hides, e.g. in case of Chromosal B is being used as a tanning agent.

In accordance with the information provided in the two examples may be performed equally effective without the samming step. I.e. to introduce the animal hides into the container without samming.

1. A process for tanning animal hides comprising the steps of:
providing a container including contents, the contents comprising a pickled hide and a tanning agent, where a total amount of water in the container is no more than 110% of a total amount of water that can be retained by the pickled animal hide, and where a total amount of tanning agent in the container is no more than 110% of a total amount of tanning agent that can be retained by the pickled animal hide, and
basifying the animal hide to bind the tanning agent in the animal hide,
where an amount of pressure inside the container is substantially similar to an amount of pressure surrounding the container or is at atmospheric pressure.

2. The process of claim 1, wherein the animal hide is sammyed prior to providing the animal hide in the container.

3. The process of claim 1, wherein contents of the container further comprise an aqueous solution.

4. The process of claim 1, wherein the tanning agent comprises one or more chemicals, the one or more chemicals being provided in a mixture or individually.

5. The process of claim 1, wherein the tanning agent comprises at least one of: a fungicide, a slippery agent, and a fat liquor.

6. The process of claim 1, wherein the total amount of water that can be retained in the animal hide is calculated based on the initial weight of the animal hide prior to a de-liming step of the animal hide.

7. The process of claim 1, wherein the total amount of water in the container is no more than 105% of the total amount of water that can be retained by the pickled animal hide.

8. The process of claim 1, wherein the total amount of tanning agent in the container is no more than 105% of the total amount of tanning agent that can be retained by the pickled animal hide.

9. The process of claim 3, wherein a pH of the aqueous solution is less than 7.

10. The process of claim 1, wherein an aqueous solution is added to the container so that the total amount of water in the container does not exceed more than 110% of the total amount of water that can be retained by the pickled animal hide.

11. The process of claim 1, wherein an amount of water retained in the animal hide is reduced to approximately 50-90% of the total amount of water that can be retained by the pickled animal hide prior to providing the animal hide in the container.

12. The process of claim 1, wherein the total amount of tanning agent is calculated based on the initial weight of the animal hide prior to a de-liming step of the animal hide.

13. The process of claim 1, wherein the total amount of water in the container is no more than 100% of the total amount of water that can be retained by the pickled animal hide.

14. The process of claim 1, wherein the total amount of water in the container is no more than between 90-99% of the total amount of water that can be retained by the pickled animal hide.

15. The process of claim 1, wherein the total amount of tanning agent in the container is no more than 100% of the total amount of tanning agent that can be retained by the pickled animal hide.

16. The process of claim 3, wherein a pH of the aqueous solution is less than 6.

17. The process of claim 3, wherein a pH of the aqueous solution is less than 5.

18. The process of claim 3, wherein a pH of the aqueous solution is less than 4.
